(19) United States
(12) Patent Application Publication
(10) Pub. No.: US 2026/0220168 A1
(43) Pub. Date: Jul. 30, 2026

(54) MANAGING GENERATION OF REFINED PROMPT AND RESPONSE PAIRS OVER TIME FOR COMPUTATIONAL EFFICIENCY

(71) Applicant: Dell Products L.P., Round Rock, TX (US)

(72) Inventors: FNU JASLEEN, Austin, TX (US); DHARMESH M. PATEL, Round Rock, TX (US)

(21) Appl. No.: 19/170,238

(22) Filed: Apr. 4, 2025

Related U.S. Application Data
(60) Provisional application No. 63/751,391, filed on Jan. 30, 2025.

(51) Int. Cl. G06F 16/3329

(52) U.S. Cl. CPC G06F 16/3329

(57) ABSTRACT

Methods and systems for managing operation of a request processing pipeline are provided. To service requests, the request processing pipeline may accept unstructured text based requests. The unstructured text may be used to obtain prompts for evaluation by a trained generative machine learning model. The pairs may be evaluated to rank order them with respect to one another. A best ranked one of the pair may be used to service the request. The request may be serviced by providing the response of the best ranked one of the pairs, by initiating provisioning of computer implemented services using the response, and/or via other processes.

### CROSS REFERENCE

This application claims the benefit of Provisional Application No. 63/751,391 titled “RESPONSE EVALUATION” and filed on Jan. 30, 2025, the contents of which are incorporated by reference herein.

### FIELD

Embodiments disclosed herein relate generally to servicing of requests. More particularly, embodiments disclosed herein relate to systems and methods to service requests using generative artificial intelligence.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2E show data flow diagrams illustrating processing and use of data in accordance with an embodiment.

FIGS. 2F-2I show diagrams illustrating information tables in accordance with an embodiment.

FIGS. 3A-3E show flow diagrams illustrating methods in accordance with an embodiment.

FIG. 4 shows a block diagram illustrating a data processing system in accordance with an embodiment.

### DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of request processing pipelines. The request processing pipelines may service requests using generative artificial intelligence. The requests may be originated from chat bots, portals, or other interfaces through which users may submit free form textual descriptions of questions, goals, etc.

The generative artificial intelligence may be provided using large language models. However, the large language models may be adapted to specific information domains and styles of input. To align the requests with the domains and/or styles, the requests may be reformulated and supplemented. The finalized requests may be submitted for processing.

To efficiently identify which response provided by the large language models to use to service a request, the refined prompt-response pairs may be scored. The best ranked refined prompt-response pair may then be used to service the request.

By doing so, embodiments disclosed herein may facilitate request processing in a computationally efficient manner while improving the likelihood of responses used to service the requests being deemed to be desirable.

In an embodiment, a method for servicing requests is provided. The method may include obtaining a prompt for processing by a trained generative machine learning model; obtaining, using a style alignment model, refined prompts based on the prompt and contextual information; generating corresponding responses for the refined prompts using the trained generative machine learning model; selecting one of the corresponding responses; and using the one of the corresponding responses to service the prompt.

The style alignment model may include a second trained generative machine learning model.

The second trained generative machine learning model may include attention layers.

The second trained generative machine learning model may be based on a frontier model, and the attention layers are a fine-tuned version of attention layers from the frontier model.

The style alignment model may be based on refinement data that may include previously serviced prompts; previously generated refined prompts for the serviced prompts; previously generated responses to the previously generated refined prompts; and scores ascribed to the previously generated responses.

The refinement data may be limited to an information domain.

The style alignment model and the trained generative machine learning model may both be fine-tuned for the information domain.

The prompt may be obtained from one selected from a group consisting of: a chat interface of a computer program that provides desired computer implemented services using the response; a portal; and an application programming interface.

Using the one of the corresponding responses may include generating a response package based at least on the one of the corresponding responses; and providing the response package to an entity that initiated the prompt; and obtaining feedback from the entity regarding a desirability of the one of the corresponding responses.

The desirability of the one of the corresponding responses may be expressed as a preference between the one of the corresponding responses and another of the corresponding responses.

The method may also include updating operation of the trained generative machine learning model based, at least in part, on the desirability of the one of the corresponding responses.

The method may also include updating operation of the style alignment model based, at least in part, on the desirability of the one of the corresponding responses.

Using the one of the corresponding responses may also include using the one of the corresponding responses to provide the desired computer implemented services.

In an embodiment, a method for servicing requests is provided. The method may include obtaining a prompt for processing by a trained generative machine learning model; obtaining, using permissions for a requestor and a contextual information data source, refined prompts based on the prompt; generating corresponding responses for the refined prompts using the trained generative machine learning model; selecting one of the corresponding responses; and using the one of the corresponding responses to service the prompt.

The permission for the requestor may be based on a role of the requestor.

Obtaining the refined prompts may include obtaining, using the contextual information data source, chunks of information; and assigned portions of the chunks of information for contextualization of the respective refined prompts using an assignment algorithm.

Each of the refined prompts may be obtained based, at least in part, on the corresponding portions of the chunks assigned to the respective refined prompts.

A portion of contextual information for the refined prompts may be derived from the permission of the requestor.

A refined prompt of the refined prompts may include a revised statement that is based on: the prompt; the portion of the contextual information; and a portion of information from the contextual information data source.

In an embodiment, a method for servicing requests is provided. The method may include obtaining a prompt for processing by a trained generative machine learning model; obtaining a number of refined prompts based at least on the prompt, the number being based on score threshold for the refined prompts and refined prompts limit; generating corresponding responses for the number of the refined prompts using the trained generative machine learning model; selecting one of the corresponding responses; and using the one of the corresponding responses to service the prompt.

The score threshold may be a quantification for discriminating acceptable refined prompts from unacceptable refined prompts.

Obtaining the number of refined prompts may include iteratively generating ones of the refined prompts until: a one of the ones of the refined prompts is ascribed a score that meets the score threshold, or a number of the ones of the refined prompts meets the refined prompts limit.

The refined prompts limits may indicate a maximum allowable number of refined prompts that are to be generated for the prompt.

Obtaining the number of the refined prompts may include scoring each of the number of the refined prompts using a scoring system.

The scoring system may be deterministic.

The refined prompts limit may be set based on scores ascribed to past generated refined prompt-response pairs using at least the scoring system.

Each refined prompt-response pair of the refined prompt-response pairs may include one of the number of refined prompts; and one of the corresponding responses.

The scoring system may ascribe a first partial score to the one of the number of refined prompts and a second partial score to the one of the corresponding responses, and an aggregate score based on the first partial score and the second partial score.

In an embodiment, a method for servicing requests is provided. The method may include obtaining a prompt for processing by a trained generative machine learning model; obtaining a number of refined prompts based at least on the prompt; generating corresponding responses for the number of the refined prompts using the trained generative machine learning model to obtain refined prompt-response pairs; scoring the refined prompt-response pairs using at least one scoring system to identify a best ranked refined prompt-response pair of the refined prompt-response pairs; selecting one of the corresponding responses that is a member of the best ranked refined prompt-response pair; and using the one of the corresponding responses to service the prompt.

The at least one scoring system may include a first scoring system for scoring refined prompts; and a second scoring system for scoring the corresponding responses.

The scoring system may further include a schema for combining a score from the first scoring system with a score from the second scoring system to obtain a score for the refined prompt response pair.

The first scoring system, the second scoring system, and the schema may be deterministic.

The second scoring system may use natural language processing results of respective corresponding responses as input.

The natural language processing results may be quantitative assessments of the respective corresponding responses.

In an embodiment, a method for servicing requests is provided. The method may include obtaining a prompt for processing by a trained generative machine learning model; obtaining a number of refined prompts based at least on the prompt; generating corresponding responses for the number of the refined prompts using the trained generative machine learning model; selecting one of the corresponding responses using a scoring system; and using the one of the corresponding responses to service the prompt.

The scoring system may be a multidimensional scoring system.

The multidimensional scoring systems may be adapted to generates sub-scores for at least: sentiment; relevancy; clarity; fairness; and conciseness.

The sentiment may quantify a likelihood of a given response being viewed as emotionally positive to a requestor.

The relevancy may quantify a likelihood of a given response to be viewed as satisfying at least one questions present in the prompt.

The conciseness may be based on a ratio of words in a given response deemed to be important to a total number of words in the given response.

In an embodiment, a non-transitory media is provided that may include instructions that when executed by a processor cause any of the above noted methods to be performed.

In an embodiment, a data processing system is provided that may include the non-transitory media and a processor, and may perform any of the above noted methods when the computer-instructions are executed by the processor.

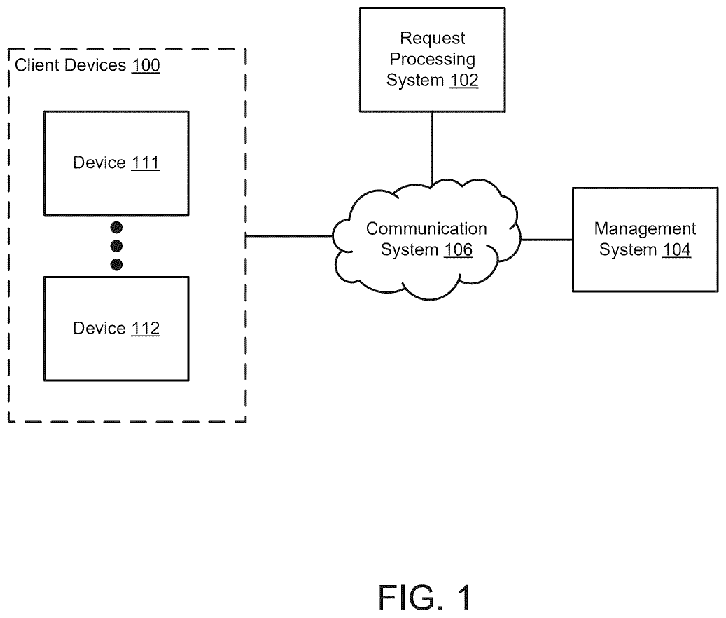

Turning to FIG. 1, a block diagram of a system in accordance with an embodiment is shown. The system may provide any number and type of computer implemented services.

To provide the computer implemented services, various components of the system may interface with one another. For example, different components of the system may contribute to different portions of the computer implemented services. To facilitate cooperation, these different components may present interfaces to one another and through which various requests may be received (e.g., from other components) and processed. The requests may include any number and types of requests. For example, the request may include requests for information, requests for changes in operation of the system, user initiated requests (e.g., a user may provide user input to form a request), etc.

To service the requests, the requests may need to be processed. However, to process the requests in a desirable manner, the request processor may need to be able to interpret the requests as intended by an issuer of the request. For example, when a user provides user input to define the content of a request, the user may do so using terminology and phrasing that is understandable by the user. However, the request processor may not be aligned with the manner of interpretation of the user.

For example, to process such requests, the system may utilize large language models to interpret and generate responses to the content of the requests. However, the large language models may be based on training data sets that are not aligned with the manner of expression that the user uses when preparing the content of the requests. Consequently, the large language models may misinterpret the content of the requests. Accordingly, the requests may not be processed in a desirable manner due to misaligned between the manner of expression of a creator of the content of a request and the manner of interpretation of the request processor. Therefore, the requests may not be processed in a desirable manner.

If the requests are not processed in a desirable manner, then responses, actions, etc. that are provided/performed to service the requests may not meet the expectations of the requestor. For example, extraneous or otherwise unhelpful information may be provided as responses to requests for information. If such information is then subsequently utilized, the resulting outcomes (e.g., various performed computer implemented services) may also be undesirable.

In general, embodiments disclosed herein relate to systems, methods, and devices for improving the likelihood of computer implemented services provided by systems meeting the expectations of requestors of the services (e.g., being desirable). To improve the likelihood, a request processing pipeline may be utilized. The request processing pipeline may at least attempt to (i) improve alignment of the content of requests with the manners in which the content is interpreted by request processors, (ii) evaluate a range of different content alignment modalities and corresponding responses generated for the range of different content alignments to obtain pairs of requests and corresponding responses, (iii) computationally efficiently analyze the modified content of requests and corresponding responses to rank the responses, (iv) use a response of the responses based on the rankings of the responses to service the original request, and (v) update operation of models used to generate the refined requests and/or responses.

By doing so, embodiments disclosed herein may improve the likelihood of computer implemented services provided by a system being deemed desirable by the entities for which the services are performed. Thus, embodiments disclosed herein may address, among others, the technical problem of misinterpretation of requests in distributed system.

The system may improve the likelihood of requests being properly interpreted through the use of a request processing pipeline that attempts to align and evaluate multiple aligned versions of requests with the manner in which the requests are likely to be interpreted.

To provide the above noted functionality, the system may include any number of client devices 100, request processing system 102, management system 104, and communication system 106. Each of these components is discussed below.

Client devices 100 may be used by users of the distributed system. Client devices 100 may facilitate acquisition of user input and provisioning of services to the users. As part of the provisioning of the computer implemented services, client devices 100 may generate and send requests to request processing system 102 for servicing. The requests may be generated, for example, using user input from the users, using content generated by instances of various applications, and/or via other methods. Any number of users may utilize any number of the client devices (e.g., 111-112).

While described and illustrated as being separate from request processing system 102, it will be appreciated that request processing system 102 may perform all, or a portion, of the functionality of any of client devices 100.

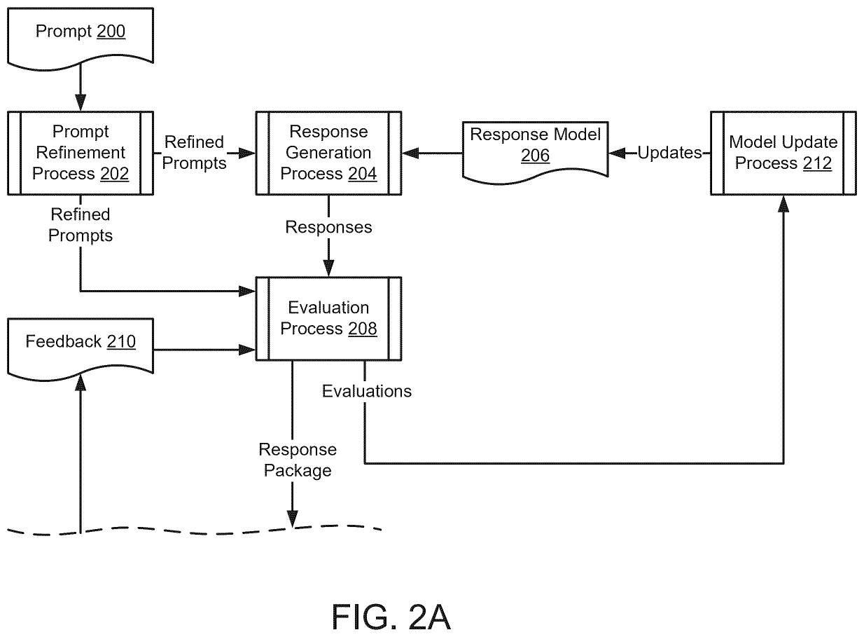

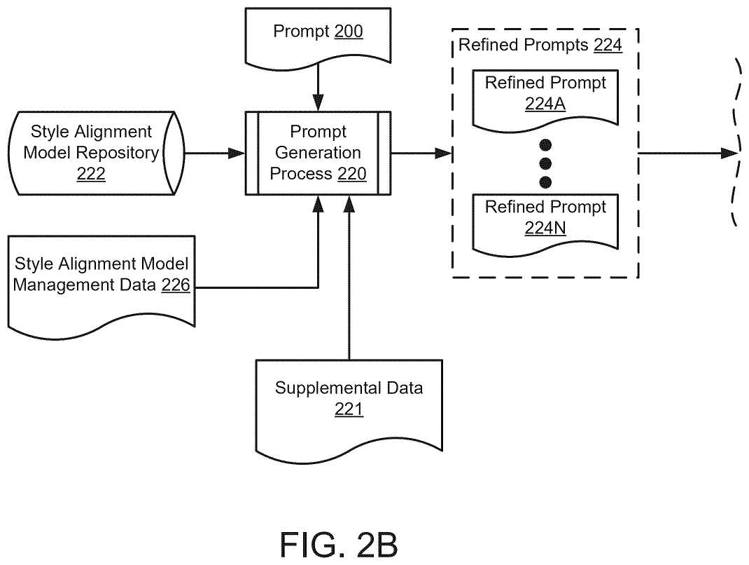

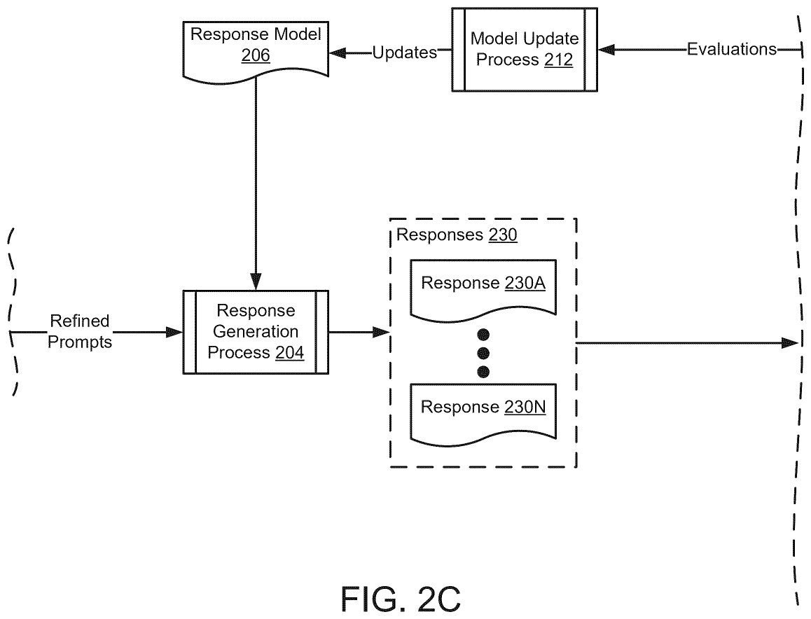

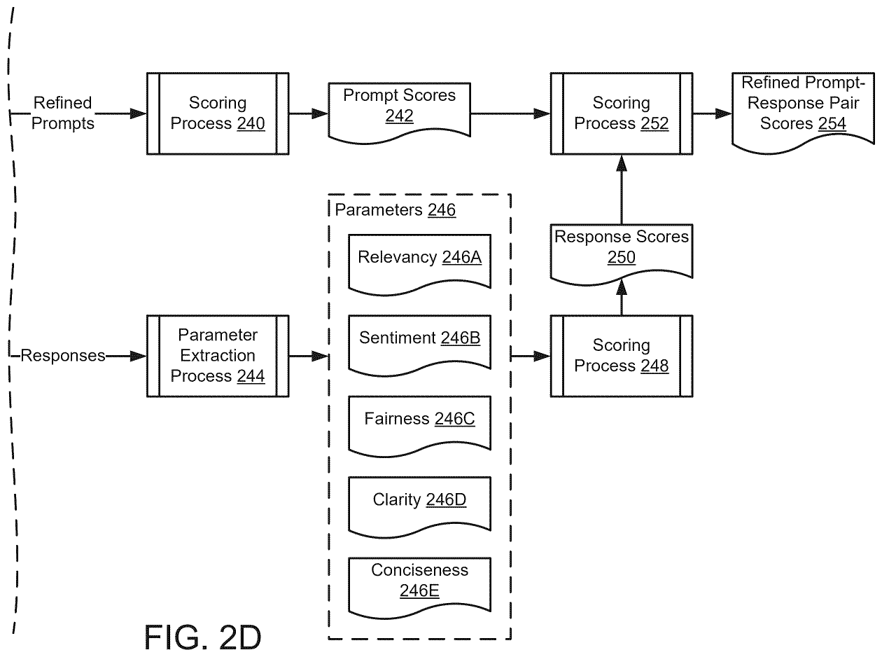

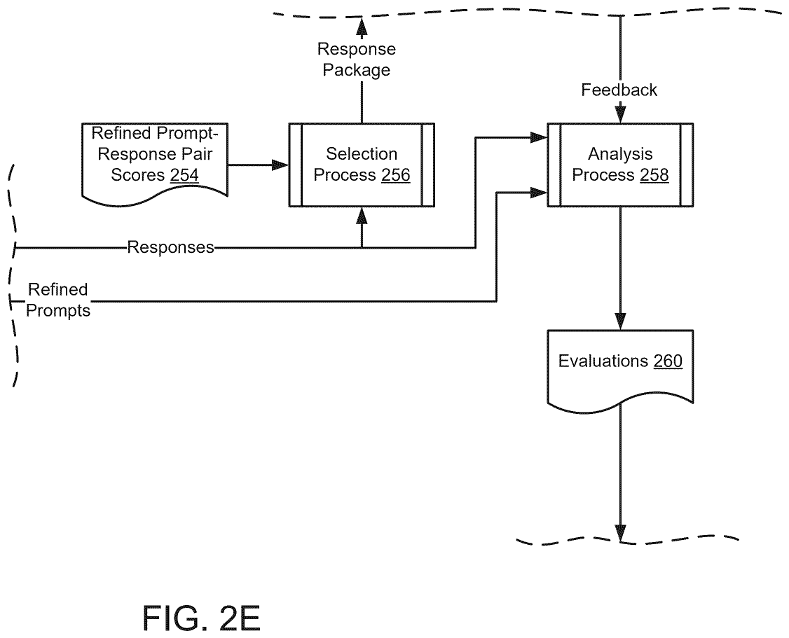

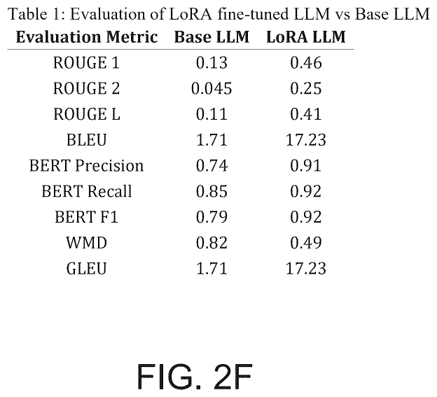

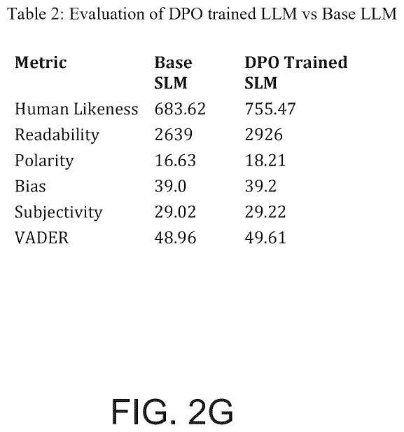

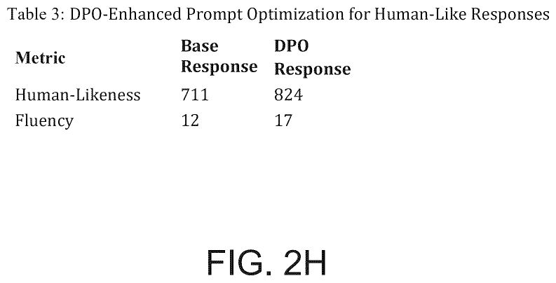

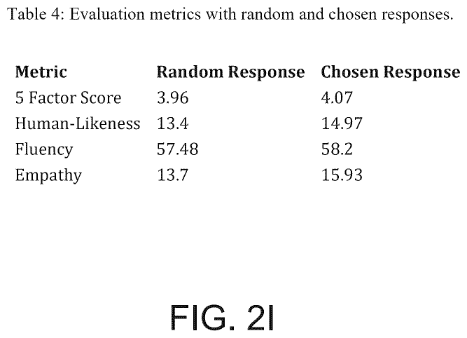

Request processing system 102 may host the request processing pipeline, and use the request processing pipeline to service requests from client devices 100, and/or other entities. Refer to FIGS. 2A-2E for additional details regarding the request processing pipeline.

Management system 104 may manage operation of request processing system 102. For example, management system 104 may modify the configuration of the request processing pipeline, modify components of the request processing pipeline, instantiate new instances of the request processing pipeline (e.g., for load balancing purposes, address resource constraints, etc.), and/or otherwise change the manner in which requests are serviced.

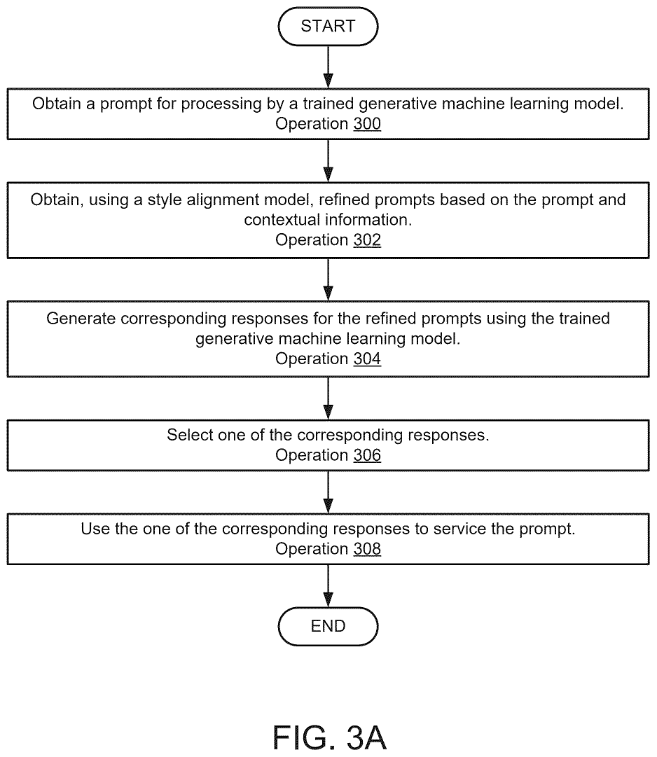

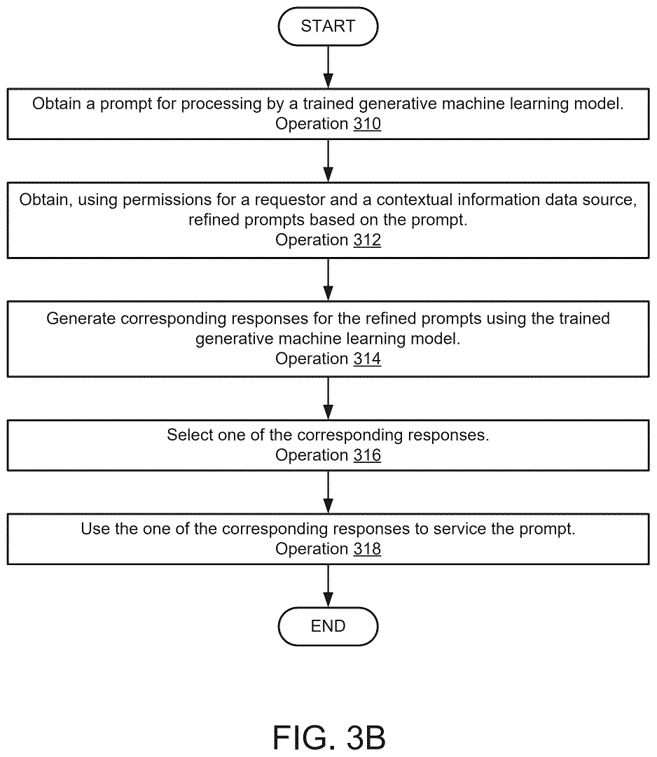

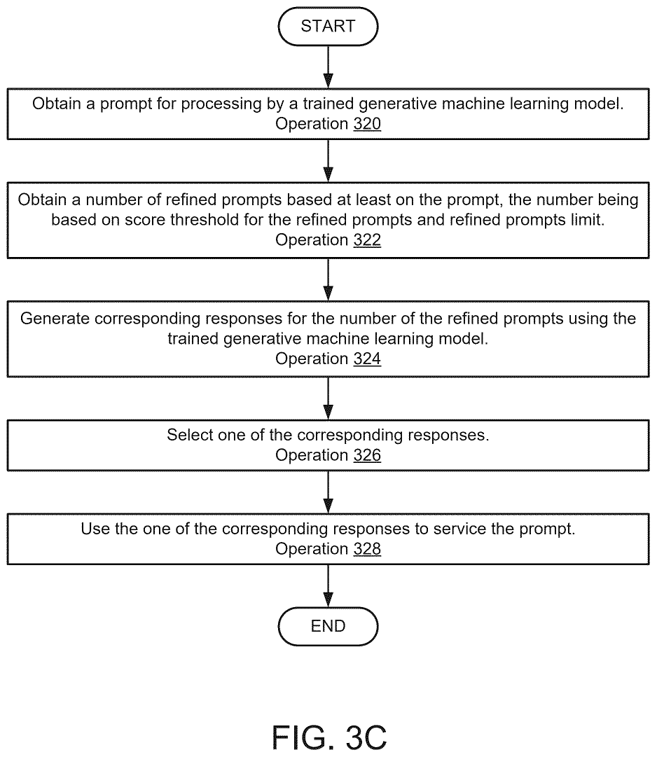

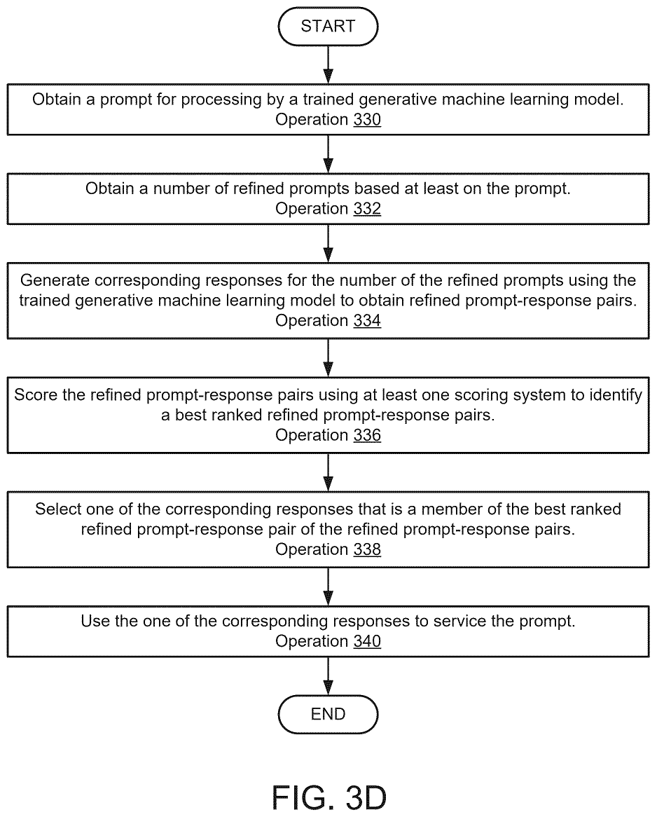

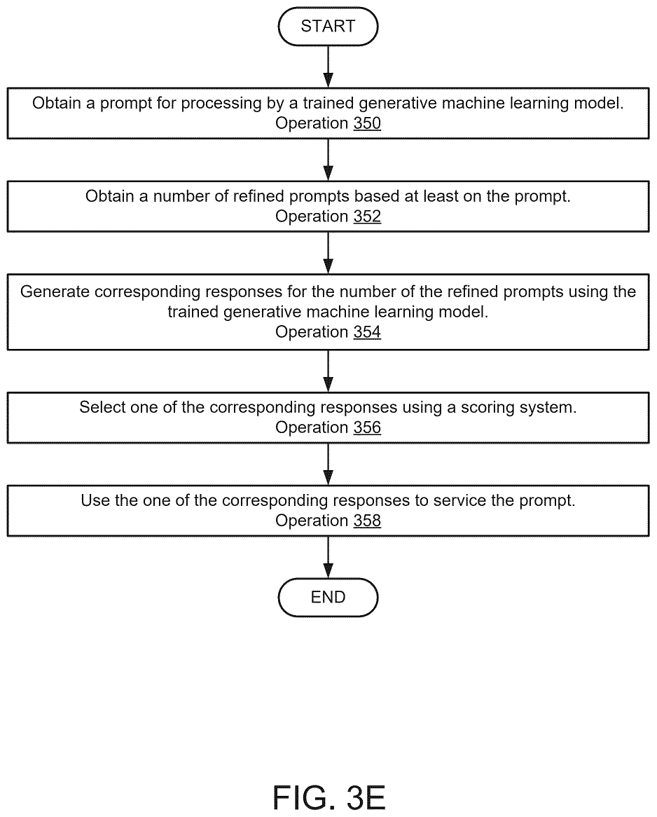

When providing their functionality, client devices 100, request processing system 102, and/or management system 104 may perform all, or a portion, of the flows and/or methods shown in FIGS. 2A-2E and 3.

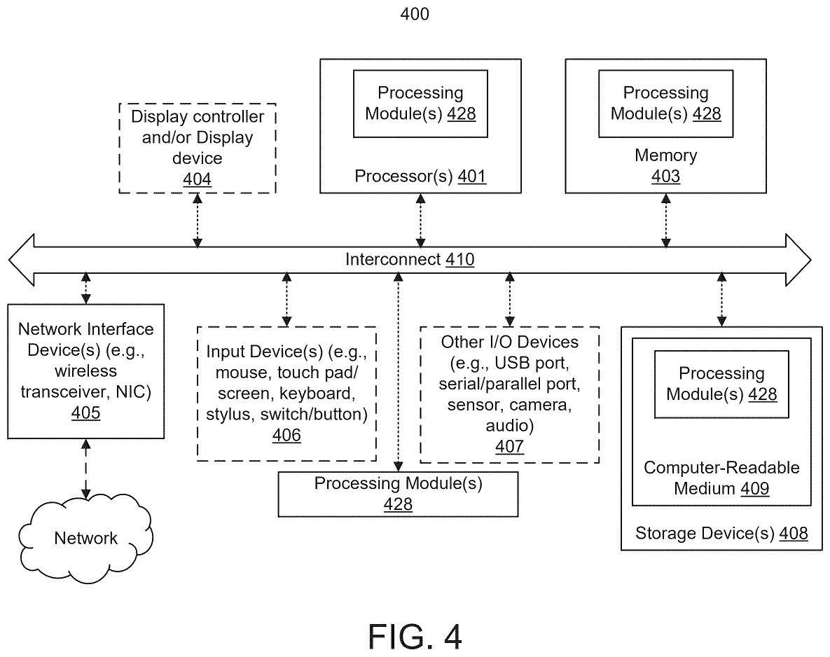

Any devices (and/or components thereof) included in the system shown in FIG. 1 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with a communication system (e.g., 106) utilized by client devices 100, request processing system 102, and/or management system 104. In an embodiment, this communication system includes one or more networks that facilitate communication between any number of components (e.g., including others not shown in FIG. 1). The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2E. These data flow diagrams may illustrate how data may be obtained and used within the system of FIG. 1.

In the data flow diagrams, flows of data and processing of data are illustrated using different sets of shapes. In the context of these data flow diagrams, a first set of shapes (e.g., 200, 206, etc.) is used to represent data structures, a second set of shapes (e.g., 202, 204, etc.) is used to represent processes performed using and/or that generate data, and a third set of shapes (e.g., 222, etc.) is used to represent large scale data structures such as databases.

Turning to FIG. 2A, a first data flow diagram in accordance with an embodiment is shown. The first data flow diagram may illustrate data used in and data processing performed in operation of a request processing pipeline.

As discussed above, various requests may be processed by the request processing pipeline. The requests may be of any type, may include unstructured information such as free form text, and may be generated via any process (e.g., based on user input, generated by an application, etc.). Thus, the content of the requests may not conform to any schema, structured data format, etc.

To process the requests, all or portion of the content of a request may be treated as a prompt for analysis using a large language model to generate a response. For example, a user may utilize an application that may present a chat interface (e.g., to address user questions, manage user encountered issues, etc.). Using the chat interface, the user may generate free form text to define, for example, a question, an instruction, etc. The captured content may then be treated as prompt 200 (e.g., before/after transmission to a request processing system).

Once prompt 200 is obtained, prompt refinement process 202 may be performed. During prompt refinement process 202, refined prompts may be generated based on prompt 200. The refined prompts may be more likely to match style expectations of a large language model that may process the refined prompts to obtain corresponding responses. Refer to FIG. 2B for additional information regarding generation of refined prompts.

Once the refined prompts are obtained, response generation process 204 may be performed. During response generation process 204, the refined prompts may be ingested by a response model (e.g., 206, may be a large language model) to obtain corresponding responses. Refer to FIG. 2C for additional information regarding generation of responses corresponding to the refined prompts.

Once the refined prompts and/or the responses are obtained, evaluation process 208 may be performed. During evaluation process 208, the refined prompt-response pairs may be evaluated to rank order the refined prompt-response pairs. A response from a best ranked refined prompt-response pair may be selected for servicing the request. For example, the response may be provided back to a user via an interface, the response may be used to drive operation of a client device, and/or the response may otherwise be used to provide desired computer implemented services.

Once provided, feedback 210 on desirability of the response may be collected. The feedback and evaluations of the refined prompt-response pairs may be used to update (i) response model 206, (ii) models used in prompt refinement, and (iii) management data used in managing generation of the refined prompts (e.g., may define numbers of refined prompts to be generated). Refer to FIGS. 2D-2E for additional information regarding evaluation of refine prompt-response pairs, and subsequent use for updating operation of the pipeline.

Thus, via the flow shown in FIG. 2A, embodiments disclosed herein may facilitate servicing of requests in a manner that is more likely to result in the manner of servicing being deemed to be desirable by users of the response processing pipeline.

Turning to FIG. 2B, a second data flow diagram in accordance with an embodiment is shown. The second data flow diagram may illustrate data used in and data processing performed in generation of refined prompts for use in a response processing pipeline.

As discussed with respect to FIG. 2A, multiple refined prompts may be generated and used to drive generative trained machine learning models to obtain corresponding responses. To obtain refined prompts 224, prompt generation process 220 may be performed. During prompt generation process 220, (i) a style alignment model may be used to perturbate prompt 200 and (ii) the content of prompt 200 may be supplemented with supplemental data 221. The resulting refined prompts 224 may, therefore, be based on prompt 200 with changes made based on the style alignment model and supplemented with additional information (e.g., context) with supplemental data 221.

For example, prompt 200 may be refined using a fine-tuned Small Language Model (SLM) combined with a Retrieval-Augmented Generation (RAG) system to obtain and integrate supplemental data 221 into refined prompts 224. The SLM and supplementation process may result in the generation of multiple refined prompts having variations (e.g., style and/or content) for the content of prompt 200 and supplemental data 221.

The SLM may be implemented using a fine-tuned version of an existing language model (e.g., may be refined with Parameter Efficient Fine-Tuning or other techniques). The SLM may be fine tuned for a particular domain using a corresponding training data set. Consequently, when prompt 200 and supplemental data 221 are used as a prompt for the SLM, the SLM may generate a response that is better aligned with the particular domain for which the SLM has been fine-tuned. The SLM may be fine tuned for a domain for which a large language model (e.g., response model 206) may be used to generate responses to prompt 200. Refer to FIG. 2C for additional information regarding response model 206.

To adapt the SLM to a particular domain, attention layers of the model may be modified to better handle the task of prompt refinement. During the refinement, information regarding past refinement attempts and rankings for the refinements may be used in reinforcement learning or other refinement processes. Refer to FIG. 2D for additional information regarding ranking of refined prompts (and/or corresponding responses).

The RAG process may be implemented using any process, and may utilize any number of data sources (e.g., specific data repositories). For example, prompt 200 may be used as a basis for generation of a query compatible with a retrieval system used to manage the data sources. The query may be run against the data sources to obtain supplemental data. The data sources may include, for example, user-specific information to enhance the refinement process.

For example, when a user submits a text used as prompt 200 (e.g., such as ‘create a trip for me in summer’), the RAG process may refine the text by incorporating the user's current location (to suggest nearby travel options) and/or historical travel data (to personalize recommendations based on preferences), presuming that such relevant information is available in the data sources used for RAG. It will be appreciated that other contextual information may be incorporated via RAG processing without departing from embodiments disclosed herein.

To facilitate efficient execution on low-compute devices, a 3-billion-parameter model (or other low resource cost model architecture) for fine-tuning may be used. Once selected, the model may be optimized for a specific domain (e.g., via fine-tuning, reinforced learning, etc.). Thus, the resulting style alignment models stored in style alignment repository 22 may be domain specific to provide for refined prompts that are more likely to be better aligned with trained generative machine learning models used to service refined prompts 224.

During prompt generation process 220, the degree of perturbation, the number of refined prompts that are to be generated, and/or other aspects of the process may be defined by style alignment model management data 226. For example, style alignment model management data 226 may include seeds to define how prompt 200 is perturbated by the style alignment models, quantifications regarding the number of refined prompts to be generated, etc.

To improve the efficiency of prompt generation process 220 and subsequent processes that utilize refined prompts 224, the number of refined prompts, the seeding, and/or other aspects of the process may be modified over time. For example, as the style alignment models become more efficient at generating desirable refined prompts, the number of refined prompts to be generated and/or the seeding used in the generation may be reduced (e.g., in contrast, when the process is inefficient, the process may be seeded aggressively and total number of refined prompts to be generated may be increased to improve the likelihood of obtaining at least one highly ranked refined prompt, while being much more computationally costly).

The seeding process may include, for example, linguistic seeding, example-based seeding, style and tone seeding, iterative seeding, and/or other seeding methods and/or combinations of methods.

The perturbation process may include, for example, word replacement, noise addition, adversarial prompting, data augmentation, prompt fading, and/or other perturbation methods and/or combinations of methods.

Thus, via the flow shown in FIG. 2B, embodiments disclosed herein may facilitate generation of refined prompts that are more likely to be serviced using the response processing pipeline resulting in desirable responses to original prompts being obtained.

Turning to FIG. 2C, a third data flow diagram in accordance with an embodiment is shown. The third data flow diagram may illustrate data used in and data processing performed in generation of responses for refined prompts for use in a response processing pipeline.

After the refined prompts are generated, response generation process 204 may be performed. During response generation process 204, the refined prompts may be used as input for response model 206. Response model 206 may generate corresponding responses 230 thereby obtaining refined prompt-response pairs.

Response model 206 may be implemented using instruction fine-tuned Response Small Language Model. This model may be derived from established architectures (e.g., a foundational/frontier model), with adaptations tailored for specific applications and performance optimization.

Each refined prompt may serve as separate input to response model 206, which may produce a corresponding response. Parameters of response model 206, such as temperature, top-k, and top-p may be used to balance randomness and relevance, thereby improving the likelihood of obtaining diverse and meaningful responses. Generating multiple responses may allow for selecting a response for the user which is more likely to be deemed to be desirable.

While described with respect to temperature (e.g., controls how much randomness is introduced in the text generation process), top-k (e.g., controls tokens number of most likely tokens to use as input) and top-p (e.g., controls how many words are considered candidates for the next word in the text generation process), other parameters (e.g., presence penalties which may controls how much the generated text reflects the presence of certain words or phrases in the output text so far) may be modified to establish a set of responses 230 meeting desired response diversity metrics. Like the perturbations of the refined prompts, the responses may be similarly perturbated in this manner to establish diverse sets of refined prompt-response pairs.

To improve the quality of responses generated over time, evaluations of the refined prompt-response pairs may be used to drive updating of response model 206 during model update process 212. During model update process 212, various aspects of response model 206 may be updated such as, for example, neuron weights, attention weights, parameters, etc. Response model may be updated based on the evaluations using any model update algorithm (e.g., supervised fine-tuning, parameter efficient fine-tuning, etc.).

Thus, via the flow shown in FIG. 2C, embodiments disclosed herein may facilitate generation of refined prompt-response pairs for use in the response processing pipeline.

Turning to FIG. 2D, a fourth data flow diagram in accordance with an embodiment is shown. The fourth data flow diagram may illustrate data used in and data processing performed in scoring of refined prompt-response pairs for use in a response processing pipeline.

As discussed above, multiple refined prompt-response pairs may be generated for servicing of a request. To ascertain which of the refined prompt-response pairs to use to service the request, the refined prompt-response pairs may be scored. During the scoring, the refined prompts and corresponding responses may be separately scored, and a combined aggregate score for each refined prompt-response pair may be generated using the separate scores.

For example, a refined prompt from a refined prompt-pair may be scored via scoring process 240. During scoring process 240, the refined prompt may be scored (e.g., using a scoring system) using, for example, natural language processing or other computationally efficient process. The natural language process may be performed to analyze one or more criteria. The criteria may include any of: completion (e.g., recall, F1-score, precision, error analysis, etc.), detail (e.g., extent to which the response addresses information conveyed by the prompt), clarity (e.g., whether the response is clear and easy to understand or complex/ambiguous), engagement (e.g., response rate, time spent interacting, user satisfaction, and the frequency of follow-up questions), creativity (e.g., assessing originality, usefulness, and novelty using techniques such as lexical diversity score, novelty detection, divergent association task, etc.), structure (e.g., sentence length distribution, paragraph structure analysis, and the presence of specific structural elements), tone (e.g., sentiment analysis using metrics such as polarity score, subjectivity score, etc., may take into account word frequency analysis and/or rule-based approaches), and conciseness (e.g., extent of irrelevant information when compared to the prompt and with respect to a total size of the response).

The scoring system may generate quantifications ranging from 0 to 5 (or other scale), where 0 represents the lowest quality and higher scores indicate more desirable prompts. Each prompt may be assigned a unique score, denoted as PS1, PS2, . . . , PSn.

The number of generated prompts may depend on the threshold for acceptable scores and the maximum allowable number of generated prompts. For example, if the goal is to achieve a score of 4 and the threshold for generated prompts is set to 5, the process may terminate as soon as a prompt scores 4 or higher. If five prompts are generated and none achieves a score of 4, for example, no additional prompts may be generated. Such settings for evaluation of the refined prompts may be established by users, subject matter experts, in automated manners, and/or via other methods.

Each of the refined prompts may be scored in this manner to obtain prompt scores 242.

Like the refined prompts, the corresponding responses may also be scored. However, the responses may be scored using an initial extraction process to extract information from the responses which may then be scored using a scoring system.

For example, parameter extraction process 244 may be performed to extract parameters 246 from each response. The resulting parameters for a given response may include relevancy 246A, sentiment 246B, fairness 246C, clarity 246D, and conciseness 246E. The individual parameters may be quantified via calculation of individual scores for each parameter.

To evaluate the relevance of an answer to a given question (e.g., refined prompt) to obtain relevancy 246A, a semantic similarity approach may be used that produces a relevance score ranging from 0 to 1. This score may be derived by calculating the degree of similarity between the question and answer using cosine similarity on their embeddings. The pre-trained ‘all-MiniLM-L6-v2’ model, for example, may be used from the sentence-transformers library to generate sentence embeddings that capture the semantic meaning of the text. A score of 1 may indicate a perfectly relevant answer, while a score of 0 may indicate complete irrelevance.

This approach may take advantage of the model's capability to capture deep semantic relationships, making it resilient to variations in wording and effective for both concise and detailed responses. The model's embeddings may effectively handle diverse textual structures, ensuring robustness in assessing relevance across different types of input.

To evaluate the sentiment of the answer to the given question to obtain sentiment 246B, a pre-trained sentiment analysis tools such as VADER (Valence Aware Dictionary and Sentiment Resonator), which is part of the NLTK library, may be used. Normalized VADER's compound scores may be used, which may range from −1 to 1, to a scale from 0 to 1. This normalization may simplify interpretation and usability for analysis and reporting. This method may enable rapid sentiment assessment without compromising accuracy.

To evaluate fairness of the answer to the given question to obtain fairness 246C, fairness may be calculated to ensure that the response does not disproportionately favor or discriminate against any group based on attributes such as gender, race, ethnicity, or other sensitive factors. In the context of Natural Language Processing (NLP), fairness may be calculated by identifying biases in language to ensure that responses are neutral, inclusive, and free from harmful stereotypes or discriminatory content.

Bias detection may be performed by analyzing the response for potential discriminatory language, such as gender or racial bias. A zero-shot classification model such as ‘facebook/bart-large-mnli’ may be used, which may classify text into predefined categories. A set of bias-sensitive categories (e.g., “gender bias,” “racial bias,” etc.) may be defined and used to classify the response into one of these categories. In addition, an inclusivity check may be used to assess whether the language used is inclusive and free from harmful stereotypes or exclusionary language. The representation of diverse groups in the response may also be evaluated, ensuring that no group is marginalized or underrepresented.

The fairness score may be measured on a scale from 0 to 1, where a score of 1 indicates that the response is highly fair and unbiased, while a score closer to 0 suggests the presence of bias or discrimination. A comprehensive evaluation of fairness may be provided, which is scalable to large datasets and a wide range of applications.

To evaluate clarity of the answer to the given question to obtain clarity 246D, clarity may be calculated by combining any of the following factors: readability and grammar quality. Readability may measure how easy or difficult a text is to understand, and the readability may be assessed using the Flesch-Kincaid Grade Level. This formula may consider the average number of syllables per word and the average number of words per sentence, with a lower grade level indicating easier readability. For grammar quality, the Language Tool library may be used to check for spelling and grammatical errors. By combining readability and grammar checks, this approach may effectively capture both the ease of reading and the grammatical correctness of a response.

To evaluate conciseness of the answer to the given question, a conciseness score may be calculated to evaluate the efficiency of a given text response by measuring the proportion of “important” words relative to the total word count, considering their length. A higher score may indicate a greater presence of meaningful words within the response. While this approach may provide an approximation of conciseness, the approach may balance accuracy of the identified conciseness against computation cost for identifying the conciseness.

Once parameters 246 for a given response are obtained, scoring process 248 may be performed. During scoring process 248, sub-parameter (e.g., 246A-246E) may be scored on a scale from 0 to 1, with 0 indicating poor performance. The overall response score may be calculated as the sum of these individual scores to obtain response scores 250, resulting in a total score ranging from 0 to 5 (or other range based on the range over which prompt scores 242 run to balance the relative contribution to refined prompt-response pair scores).

Once prompt scores 242 and response scores 250 are obtained, scoring process 252 may be performed. During scoring process 252, refined prompt-response pair scores 254 may be obtained. To obtain each of such scores, the score for a given refined prompt and corresponding response may be used to obtain one of the scores.

For example, an aggregate score for each prompt-response pair may be computed by summing the individual refined prompt score and the corresponding response score (or otherwise combining them using a weighted sum, mean, median, etc.). The response score may be given greater weight in the aggregate score compared to the prompt score, for example, to focus on improving the response over time, making it more human-like through Reinforcement Learning with Human Feedback (RLHF).

The total score for each refined prompt-response pair may range from 0 (0+0) to 10 (5+5). By selecting the response from the refined prompt-response pair having the highest total score, a high quality response may be more likely to be obtained, thereby enhancing the overall user experience. This quantitative scoring method may reduce computational overhead while maintaining response quality. The method may also provide a supplementary layer of evaluation for prioritizing outputs that are sentimentally meaningful and free from bias.

The scoring methodology may utilize a dual-scoring mechanism, independently assessing both prompts and responses. This independent evaluation may increase granularity and mitigate the risk of reward hacking, establishing a robust and unbiased assessment framework.

Thus, via the flow shown in FIG. 2D, embodiments disclosed herein may facilitate ranking of refined prompt-response pairs.

Turning to FIG. 2E, a fifth data flow diagram in accordance with an embodiment is shown. The fifth data flow diagram may illustrate data used in and data processing performed in use of refined prompt-response pairs.

To service the original request, one of the responses from the refined prompt-response pairs may be selected during selection process 256. During selection process 256, the responses may be ranked based on refined prompt-response pair scores 254. For example, the refined prompt-response pairs may be rank ordered based on refined prompt-response pair scores 254, and a response from one of the refined prompt-response pairs (e.g., a best ranked) may be selected to service a request.

Once selected, a response package may be generated and sent to an original requestor (e.g., from which the original prompt is obtained) for use (e.g., in any process for which the original request was initiated) and evaluation. For example, feedback from the original requestor regarding desirability of the response (or multiple responses should multiple responses be included in the response package for potential use and evaluation, some number of highly ranked responses may be included in the response package).

Once the feedback is obtained, analysis process 258 may be performed. During analysis process 258, the refined prompt-response pairs may be analyzed in view of the feedback to ascertain desirability of the refined prompt-response pairs. The desirability may be stored as evaluations 260 and in turn used to update operation of any of the trained generative machine learning models (e.g., style alignment models, response model 206, etc.).

For example, the Response Small Language Model (SLM) may be further fine tuned using Parameter-Efficient Fine-Tuning (PEFT) and/or a Direct Preference Optimization (DPO) trainer (and/or via other methods). As part of these processes, a custom dataset of prompt-response pairs related to a particular domain may be used. This dataset may be used to ensure the models are tailored to generate contextually appropriate and domain-specific refined prompts and/or responses (and/or improve alignment between the different models). It will be appreciated that similar processes may be performed for any number and type of information domains (e.g., computer problem triaging, manufacturing line problem remediation, etc.).

The DPO trainer may also be applied to the PEFT-tuned SLM using a human evaluation dataset. This dataset may include labeled responses for each refined prompt-response pair, with one response marked as “chosen” and the other as “rejected”.

Additionally, users may be presented with two responses (e.g., as part of the response package) and asked to select their preferred option. This preference data may be incorporated into a dedicated dataset, which may then be used for further fine-tuning the Response SLM via the DPO trainer. This iterative feedback loop may provide for continuous improvement, aligning the models'output more closely with human preferences and expectations.

Any of the updates may be made using model update processes, such as model update process 212 for response model 206.

Thus, via the flow shown in FIG. 2E, embodiments disclosed herein may facilitate ranking of refined prompt-response pairs.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

### Experiments and Results

Using the above described system, various test scenarios were performed as follows. It will be appreciated that the following are mere example implementations and are not to be taken as limiting.

### Experiment 1: Fine-Tuning Prompt LLM with LoRA

In the first experiment, “Llama-3.2-3B” model was fine-tuned using the Low-Rank Adaptation (LoRA) technique to enhance its performance in responding to travel-related queries. The dataset for this task was generated through various NLP techniques and is publicly available on Hugging Face hub. This dataset provides rich context for adapting the model to specific travel-related prompts.

The hyperparameters were selected based on best practices identified in previous research. The rank of the low-rank matrices was set to 64, and an alpha value of 64 was chosen to facilitate effective learning during the adaptation phase. A dropout rate of 0.1 was applied to mitigate overfitting. The model's performance was evaluated using a set of comprehensive metrics: ROUGE-1, ROUGE-2, ROUGE-L, BLEU, BERT Precision, Recall, F1, WMD, and GLEU. Results are summarized in Table 1, which shows average scores over 500 prompts and the corresponding percentage improvements in performance.

### Evaluation Metrics

To evaluate model performance, the following metrics were considered:
ROUGE-1: Measures the overlap of unigrams between the model's output and the reference text. A higher score indicates that the model is able to generate responses with more relevant words matching the reference.
ROUGE-2: Focuses on the overlap of bigrams, which evaluates how well the model captures contextual relationships and structure in its responses.
ROUGE-L: Calculates the longest common subsequence (LCS) between the predicted and reference text, rewarding the model for maintaining the correct sequence of words and context.
BLEU: BLEU evaluates the precision of n-grams between the model's output and the reference. It includes a brevity penalty to prevent models from generating overly short responses.
BERT Precision: This measures how many of the words predicted by the model are relevant and correct, focusing on the proportion of true positives in the model's responses compared to all predicted words.
BERT Recall: Calculates how many relevant words the model successfully retrieves in its output compared to all relevant words in the reference text.
BERT F1 Score: The harmonic mean of precision and recall, providing a balanced evaluation of both metrics. It reflects the model's overall ability to accurately predict relevant words without missing too many.
Word Mover's Distance (WMD): A semantic similarity measure calculates the effort required to move the words in the model's output to the words in the reference text, considering word embeddings. A lower WMD indicates that the generated response closely resembles the reference text in meaning.
GLEU: Designed to account for variations in text generation. It calculates n-gram overlap but with more flexibility, making it useful for evaluating creative text generation.

### Results and Analysis of First Experiment

The results of Experiment 1 demonstrate significant improvements with the LoRA fine-tuned model. Notably, the model showed a 22% increase in BERT precision, an 8.2% improvement in recall, and a 16% increase in F1 score, indicating better overall performance in refining travel-related prompts. The increases in ROUGE, BLEU, and WMD scores suggest that the LoRA fine-tuned model produces more contextually accurate and semantically aligned responses compared to the base LLM. Specific values are shown in Table 1 which is shown in FIG. 2F.

### Experiment 2: Evaluating Response Quality: Comparison Between DPO-trained and Base SLM

This experiment investigates how response quality improves in a small language model (SLM) when trained using a Data Provisioning Optimizer (DPO) approach compared to baseline SLM. The evaluation employs a combination of quantitative metrics and an LLM to assess response quality.

The primary objective is to evaluate the effectiveness of the DPO training method in generating responses that are not only accurate, but also exhibit enhanced human-like characteristics and empathy. By comparing the outputs of the DPO-trained model and the base LLM, this study aims to quantify performance improvements arising from advanced training methodologies.

### Evaluation Metrics

The assessment integrates quantitative metrics to evaluate response quality across dimensions such as readability, sentiment, emotional tone, and bias, alongside qualitative evaluation by an LLM. These dimensions are analyzed using the following methodologies:
Polarity and Subjectivity Analysis Polarity and subjectivity are computed using sentiment analysis models trained on large datasets.
Polarity evaluates emotional tone, ranging from −1 (negative) to +1 (positive), by analyzing sentiment lexicons and syntactic structures.
Subjectivity assesses the degree of personal opinions versus objective facts in text, with scores ranging from 0 (objective) to 1 (subjective). This analysis identifies markers like adjectives and subjective expressions to determine emotional context.
Bias Detection Bias detection utilizes a fine-tuned BERT-based model designed for identifying hate speech and biased content. Responses are classified as biased or non-biased, with a bias score indicating the likelihood of biased language. This facilitates a comparative analysis of bias levels in generated text.
Readability Assessment Readability is measured using the Flesch Reading Ease score, which evaluates text complexity based on sentence length and syllable count. Higher scores indicate simpler, more accessible text, with lower scores reflecting greater complexity.
Metrics for Human-Likeness To assess overall response quality, the following metrics are employed:
Fluency reflects text-clarity and simplicity using Flesch Reading Ease score.
Empathy analyzed using TextBlob sentiment polarity to gauge the emotional warmth and positivity of responses.
Sentiment Alignment calculated using VADER sentiment scores to measure congruence between user input and response sentiment. Lower differences indicate better alignment.
Tone Appropriateness is assessed for consistency and positivity, with responses maintaining positive or neutral tones scored higher.

### Results and Analysis

As shown in Table 2 shown in FIG. 2G, the experiment highlights the DPO training approach's potential in generating higher-quality responses. The findings demonstrate 10% improvement in human-likeness and 11% improvement in readability. By keeping bias in check and increasing readability and polarity, DPO-trained models may align more closely with the goals of responsible and empathetic AI. The results are based on responses generated by base SLM v/s DPO-trained SLM for 50 prompts.

### Experiment 3: Impact of Full Pipeline Implementation on Response Quality

In this experiment, we evaluated the complete methodology by comparing responses generated using the full pipeline against those generated directly from the original input prompt. The methodology includes refining and scoring the input prompt, generating and scoring responses, calculating total scores, extracting prompt-response pairs, and selecting the response with the highest overall score. This experiment aims to quantify the improvements in response quality achieved through our approach.

### Evaluation Metrics

This assessment utilizes two key metrics to evaluate whether response quality can be further enhanced by scoring multiple responses and selecting the one with the highest score: Human-Likeness and Fluency. These metrics collectively measure the overall quality and effectiveness of the generated responses, providing a robust framework for identifying the most suitable output.

### Results and Analysis

The results of this experiment demonstrate a significant improvement in response quality after implementing the full pipeline of our method. Specifically, human-likeness increased by 15%, while fluency saw a substantial rise of 41%. Detailed results are provided in Table 3.

### Experiment 4: Evaluating Response Scoring and Selection

In this experiment, we generated three responses from the DPO fine-tuned model and assigned a score to each using the response scoring mechanism. To assess the effectiveness of the scoring approach, a random response was selected from the three generated responses and compared with the highest-rated response based on the assigned scores.

The objective of this experiment was to evaluate whether generating multiple responses, scoring them, and presenting the highest-scoring response to the user results in outputs that are more human-like. While this method involves a higher computational cost due to the generation and evaluation of multiple responses, the overhead can be mitigated by leveraging the scoring mechanism to create a dataset. This dataset can then be used to further fine-tune the DPO-trained SLM, thereby optimizing performance and reducing computational demands in subsequent iterations.

### Evaluation Metrics

This assessment employs two key metrics to determine whether response quality can be further improved by scoring multiple responses and selecting the one with the highest score, as detailed in Table 4. The first metric, the 5-Factor Score, evaluates response quality based on five essential dimensions: sentiment, answer relevance, clarity, fairness, and conciseness, providing a holistic measure of how well the response aligns with the input prompt. The second metric, Human-Likeness, assesses the extent to which a response mimics human communication, considering various qualitative aspects.

### Results and Analysis

As demonstrated in Table 4, evaluating responses across multiple criteria and selecting the response with the highest overall score significantly enhances response quality. This approach increases Human-Likeness by 11% and improves the 5-Factor Score by 3%. While this method is computationally intensive, as it requires generating and scoring multiple responses before selecting one, it offers substantial utility for creating datasets for further fine-tuning. By iteratively generating high-scored and low-scored response datasets, this approach supports the fine-tuning of Response SLMs using a DPO Trainer. Incorporating user feedback into this process can further refine the model, resulting in an SLM capable of producing responses that are more closely aligned with human communication patterns. Over time, as the generated responses reach a certain quality threshold, the need for scoring multiple responses before presenting one to the user will no longer be required.

Thus, embodiments disclosed herein may provide a novel framework for generating human-like responses by combining fine-tuned SLMs with a dual independent scoring strategy is disclosed. The approach demonstrates the feasibility of improving the emotional quality and human-likeness of responses through quantitative evaluations of generated content. By employing this architecture, computational overhead has been reduced and the issue of reward hacking is addressed. Additionally, the focus on responsible AI ensures that generated responses are systematically checked for bias, promoting fairness and inclusivity.

To validate this method, travel data was utilized, showcasing the ability to generate high-quality responses by training small language models on domain-specific data. However, this framework is not limited to the travel domain and can be generalized to other domains or even multiple domains simultaneously. This can be achieved, for example, by training adapters and combining them during inference, enabling scalability while maintaining efficiency.

The architecture may be efficient in mitigating computational costs while enhancing domain-specific response quality and accuracy. Furthermore, this approach has the potential to evolve chatbots (or other types of conversational agents) into more empathetic and trustworthy AI agents, thereby increasing user confidence.

While generating multiple prompts and responses may initially increase latency between prompt and response, this process may improve response quality and reduces latency over iterative cycles.

As discussed above, the components of FIG. 1 may perform various methods to manage operation of a system. FIGS. 3A-3E illustrate methods that may be performed by the components of the system of FIG. 1. In the diagram discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method for servicing requests in accordance with an embodiment is shown. The method may be performed by any of the components of FIG. 1, and/or other entities without departing from embodiments disclosed herein.

At operation 300, a prompt for processing by a trained generative machine learning model may be obtained. The prompt may be obtained by reading it from storage, receiving it from another entity, generating it (e.g., based on user input), and/or via other methods.

For example, a user may use a chatbot, portal, or other interface to provide user input usable to define the prompt. The prompt may include free form text in a style aligned with that of the user (as opposed to entities that may use the resulting prompt).

In another example, the prompt may be defined using an application program interface (e.g., by a different program from the program presenting the application program interface). For example, the other program may use a language model or other entity to generate free form text defining an intent, goal, etc. The application program interface may direct the content to the request processing pipeline.

At operation 302, refined prompts that are based on the prompt and contextual information may be obtained using a style alignment model. The refined prompts may be obtained by feeding the prompt and/or the contextual information to the style alignment model as input. The style alignment model may output corresponding refined prompts (e.g., to the input).

In addition to the prompt, contextual information may also be fed to the style alignment model. The contextual information may be obtained via a retrieval augmented generation process or other type of collection process. In an embodiment, permissions, roles, or other types of user-focused management data may be used as part of the contextual information.

The style alignment model may be implemented using a trained generative machine learning model having attention layers. The trained generative machine learning model may be a fine-tuned version of a frontier model or other type of trained model. The fine tuning may modify the attention layers to modify the types of responses generated by the trained generative machine learning model.

The fine tuning may be performed using refinement data (e.g., training data). The refinement data may include any of previously serviced prompts; previously generated refined prompts for the serviced prompts; previously generated responses to the previously generated refined prompts; and scores ascribed to the previously generated responses and/or refined prompts. The content of the refinement data may be focused on a particular information domain (e.g., focused on an industry, a type of process, etc.). The fine tuning may be performed using any refinement process, and may result in a model that is more likely to produce desirable refined prompts. Both the style alignment model and the trained generative machine learning model may be fine-tuned for the same information domain (e.g., both trained using training data relevant to the information domain).

At operation 304, corresponding responses for the refined prompts may be generated using the trained generative machine learning model. The corresponding responses may be generated by feeding the refined prompts to the trained generative machine learning model as input.

At operation 306, one of the corresponding responses is selected. The one may be selected, for example, on a basis of likely desirability of the responses and/or the refined prompts. A scoring system may be used to quantify the desirability of the response (and/or corresponding refined prompt used as input to generate the response).

At operation 308, the one of the corresponding responses may be used to service the prompt. The one may be used by (i) providing the one of the corresponding responses to the entity (or designated recipient), (ii) selecting and performing one or more actions based on the one of the corresponding responses (to provide computer implemented services that are more likely to be deemed to be desirable), and/or via other methods.

For example, a response package may be generated based at least on the one of the corresponding responses. The response package may be provided to an entity that initiated the prompt. The entity may provide feedback regarding the desirability of any of the corresponding responses based on the response package.

For example, multiple responses may be provided (as part of the response package) and a user may ascribe relative or absolute levels of desirability for the respective responses.

The method may end following operation 308.

In addition to the above operation, the feedback may be used to update operation of the trained generative machine learning model and/or the style alignment model. For example, a training data set may be established using all, or a portion, of the generated refined prompt-response pairs, the entity ascribed levels of desirability of the respective responses, and/or scores for the refined prompt-response pairs (and/or portions thereof). The training data may be used to perform, for example, fine-tuning, reinforced learning, and/or other model updating processes.

Additionally, the training data may be used to refine limits on the refined prompts that are generated. For example, as desirability increases, the limits on the refined prompts that are generated (e.g., at operation 302) may be reduced to reduce computational expenditures.

Thus, via the flow shown in FIG. 3A, more desirable response may be generated and used to provide desired computer implemented services.

Turning to FIG. 3B, a second flow diagram illustrating a method for servicing requests in accordance with an embodiment is shown. The method may be performed by any of the components of FIG. 1, and/or other entities without departing from embodiments disclosed herein.

At operation 310, a prompt for processing by a trained generative machine learning model may be obtained. The prompt may be obtained by reading it from storage, receiving it from another entity, generating it (e.g., based on user input), and/or via other methods.

For example, a user may use a chatbot, portal, or other interface to provide user input usable to define the prompt. The prompt may include free form text in a style aligned with that of the user (as opposed to entities that may use the resulting prompt).

In another example, the prompt may be defined using an application program interface (e.g., by a different program from the program presenting the application program interface). For example, the other program may use a language model or other entity to generate free form text defining an intent, goal, etc. The application program interface may direct the content to the request processing pipeline.

At operation 312, refined prompts that are based on the prompt may be obtained using permissions for a requestor and a contextual information data source. The refined prompts may be obtained by feeding the prompt and/or contextual information from the contextual information data source to a style alignment model as input. The style alignment model may output corresponding refined prompts (e.g., to the input).

In addition to the prompt, the contextual information may also be fed to the style alignment model. The contextual information may be obtained via a retrieval augmented generation process or other type of collection process. In an embodiment, permissions, roles, or other types of user-focused management data may be used as part of the contextual information. The aforementioned information may be used to, for example, identify the contextual information data source (e.g., the requestor may be privileged with response to some but not all contextual information data sources).

The refined prompts may be obtained by obtaining, using the contextual information data source, chunks of information (e.g., based on similarity between the prompt and different chunks in the contextual information data source); and assigning portions of the chunks of information for contextualization of the respective refined prompts using an assignment algorithm (e.g., may be random, may enforce a distribution using a seeding process and/or algorithm, etc.).

At least a portion of the contextual information for the refined prompts may be derived from permissions granted to the requestor. For example, the permissions may be used to identify and/or infer a type of the requestor, a task assigned to the requestor, etc. The identified/inferred information may be used as part of the contextual information.

A refined prompt may include a revised statement that is based on: the prompt; the portion of the contextual information; and a portion of information from the contextual information data source. The form of the refined statement may be set, for example, using a seed or other information to manage operation of the style alignment model.

The style alignment model may be implemented using a trained generative machine learning model having attention layers. The trained generative machine learning model may be a fine-tuned version of a frontier model or other type of trained model. The fine tuning may modify the attention layers to modify the types of responses generated by the trained generative machine learning model.

The fine tuning may be performed using refinement data (e.g., training data). The refinement data may include any of previously serviced prompts; previously generated refined prompts for the serviced prompts; previously generated responses to the previously generated refined prompts; and scores ascribed to the previously generated responses and/or refined prompts. The content of the refinement data may be focused on a particular information domain (e.g., focused on an industry, a type of process, etc.). The fine tuning may be performed using any refinement process, and may result in a model that is more likely to produce desirable refined prompts. Both the style alignment model and the trained generative machine learning model may be fine-tuned for the same information domain (e.g., both trained using training data relevant to the information domain).

At operation 314, corresponding responses for the refined prompts may be generated using the trained generative machine learning model. The corresponding responses may be generated by feeding the refined prompts to the trained generative machine learning model as input.

At operation 316, one of the corresponding responses is selected. The one may be selected, for example, on a basis of likely desirability of the responses and/or the refined prompts. A scoring system may be used to quantify the desirability of the response (and/or corresponding refined prompt used as input to generate the response).

At operation 318, the one of the corresponding responses may be used to service the prompt. The one may be used by (i) providing the one of the corresponding responses to the entity (or designated recipient), (ii) selecting and performing one or more actions based on the one of the corresponding responses (to provide computer implemented services that are more likely to be deemed to be desirable), and/or via other methods.

For example, a response package may be generated based at least on the one of the corresponding responses. The response package may be provided to an entity that initiated the prompt. The entity may provide feedback regarding the desirability of any of the corresponding responses based on the response package.

For example, multiple responses may be provided (as part of the response package) and a user may ascribe relative or absolute levels of desirability for the respective responses.

The method may end following operation 318.

In addition to the above operation, the feedback may be used to update operation of the trained generative machine learning model and/or the style alignment model. For example, a training data set may be established using all, or a portion, of the generated refined prompt-response pairs, the entity ascribed levels of desirability of the respective responses, and/or scores for the refined prompt-response pairs (and/or portions thereof). The training data may be used to perform, for example, fine-tuning, reinforced learning, and/or other model updating processes.

Additionally, the training data may be used to refine limits on the refined prompts that are generated. For example, as desirability increases, the limits on the refined prompts that are generated (e.g., at operation 302) may be reduced to reduce computational expenditures.

Thus, using the flow shown in FIG. 3B, embodiments disclosed herein may facilitate integration of information from a variety of data sources into refined prompts thereby establishing a broader variability of information content of the refined prompts.

Turning to FIG. 3C, a third flow diagram illustrating a method for servicing requests in accordance with an embodiment is shown. The method may be performed by any of the components of FIG. 1, and/or other entities without departing from embodiments disclosed herein.

At operation 320, a prompt for processing by a trained generative machine learning model may be obtained. The prompt may be obtained by reading it from storage, receiving it from another entity, generating it (e.g., based on user input), and/or via other methods.

For example, a user may use a chatbot, portal, or other interface to provide user input usable to define the prompt. The prompt may include free form text in a style aligned with that of the user (as opposed to entities that may use the resulting prompt).

In another example, the prompt may be defined using an application program interface (e.g., by a different program from the program presenting the application program interface). For example, the other program may use a language model or other entity to generate free form text defining an intent, goal, etc. The application program interface may direct the content to the request processing pipeline.

At operation 322, a number of refined prompts that are based on the prompt may be obtained. The number may be based on a score threshold for the refined prompts and a refined prompts limit.

The refined prompts may be obtained by feeding the prompt and/or contextual information from the contextual information data source to a style alignment model as input. The style alignment model may output corresponding refined prompts (e.g., to the input).

In addition to the prompt, the contextual information may also be fed to the style alignment model. The contextual information may be obtained via a retrieval augmented generation process or other type of collection process. In an embodiment, permissions, roles, or other types of user-focused management data may be used as part of the contextual information. The aforementioned information may be used to, for example, identify the contextual information data source (e.g., the requestor may be privileged with response to some but not all contextual information data sources).

The refined prompts may be obtained by obtaining, using the contextual information data source, chunks of information (e.g., based on similarity between the prompt and different chunks in the contextual information data source); and assigning portions of the chunks of information for contextualization of the respective refined prompts using an assignment algorithm (e.g., may be random, may enforce a distribution using a seeding process and/or algorithm, etc.).

At least a portion of the contextual information for the refined prompts may be derived from permissions granted to the requestor. For example, the permissions may be used to identify and/or infer a type of the requestor, a task assigned to the requestor, etc. The identified/inferred information may be used as part of the contextual information.

A refined prompt may include a revised statement that is based on: the prompt; the portion of the contextual information; and a portion of information from the contextual information data source.

When generating refined prompts, the refined prompts may be scored and compared to the score threshold. The score threshold may include a quantification for discriminating acceptable refined prompts from unacceptable refined prompts. Refined prompts may continue to be generated until one has a score that exceeds the score threshold (or a predetermined number exceed the score threshold), or the refined prompt limit is reached (e.g., the refined prompts limit may indicate a maximum number that may be generated).

The refined prompts may be scored using a scoring system, which may be deterministic.

The refined prompts limit may change over time based on scores ascribed to past generated refined prompt-response pairs (e.g., using at least the scoring system). As the scores improve (e.g., indicating that the style alignment model is generating more desirable refined prompts), the refined prompts limit may be reduced (and the vice versa) and/or other management information (e.g., may require fewer predetermined numbers that exceed the limit for the generation process to be terminated before the refined prompts limit is reached).

Each refined prompt-response pair of the refined prompt-response pairs may include one of the number of refined prompts; and one of the corresponding responses. The scoring system ascribes a first partial score to the one of the number of refined prompts and a second partial score to the one of the corresponding responses, and an aggregate score based on the first partial score and the second partial score.

The style alignment model may be implemented using a trained generative machine learning model having attention layers. The trained generative machine learning model may be a fine-tuned version of a frontier model or other type of trained model. The fine tuning may modify the attention layers to modify the types of responses generated by the trained generative machine learning model.

The fine tuning may be performed using refinement data (e.g., training data). The refinement data may include any of previously serviced prompts; previously generated refined prompts for the serviced prompts; previously generated responses to the previously generated refined prompts; and scores ascribed to the previously generated responses and/or refined prompts. The content of the refinement data may be focused on a particular information domain (e.g., focused on an industry, a type of process, etc.). The fine tuning may be performed using any refinement process, and may result in a model that is more likely to produce desirable refined prompts. Both the style alignment model and the trained generative machine learning model may be fine-tuned for the same information domain (e.g., both trained using training data relevant to the information domain).

At operation 324, corresponding responses for the refined prompts may be generated using the trained generative machine learning model. The corresponding responses may be generated by feeding the refined prompts to the trained generative machine learning model as input.

At operation 326, one of the corresponding responses is selected. The one may be selected, for example, on a basis of likely desirability of the responses and/or the refined prompts. A scoring system may be used to quantify the desirability of the response (and/or corresponding refined prompt used as input to generate the response).

At operation 328, the one of the corresponding responses may be used to service the prompt. The one may be used by (i) providing the one of the corresponding responses to the entity (or designated recipient), (ii) selecting and performing one or more actions based on the one of the corresponding responses (to provide computer implemented services that are more likely to be deemed to be desirable), and/or via other methods.

For example, a response package may be generated based at least on the one of the corresponding responses. The response package may be provided to an entity that initiated the prompt. The entity may provide feedback regarding the desirability of any of the corresponding responses based on the response package.

For example, multiple responses may be provided (as part of the response package) and a user may ascribe relative or absolute levels of desirability for the respective responses.

The method may end following operation 328.

In addition to the above operation, the feedback may be used to update operation of the trained generative machine learning model and/or the style alignment model. For example, a training data set may be established using all, or a portion, of the generated refined prompt-response pairs, the entity ascribed levels of desirability of the respective responses, and/or scores for the refined prompt-response pairs (and/or portions thereof). The training data may be used to perform, for example, fine-tuning, reinforced learning, and/or other model updating processes.

Additionally, the training data may be used to refine limits on the refined prompts that are generated. For example, as desirability increases, the limits on the refined prompts that are generated (e.g., at operation 302) may be reduced to reduce computational expenditures.

Thus, using the flow shown in FIG. 3C, embodiments disclosed herein may facilitate integration of information from a variety of data sources into refined prompts thereby establishing a broader variability of information content of the refined prompts.

Turning to FIG. 3D, a fourth flow diagram illustrating a method for servicing requests in accordance with an embodiment is shown. The method may be performed by any of the components of FIG. 1, and/or other entities without departing from embodiments disclosed herein.

At operation 330, a prompt for processing by a trained generative machine learning model may be obtained. The prompt may be obtained by reading it from storage, receiving it from another entity, generating it (e.g., based on user input), and/or via other methods.

For example, a user may use a chatbot, portal, or other interface to provide user input usable to define the prompt. The prompt may include free form text in a style aligned with that of the user (as opposed to entities that may use the resulting prompt).

In another example, the prompt may be defined using an application program interface (e.g., by a different program from the program presenting the application program interface). For example, the other program may use a language model or other entity to generate free form text defining an intent, goal, etc. The application program interface may direct the content to the request processing pipeline.

At operation 332, a number of refined prompts that are based on the prompt may be obtained. The number may be based on a score threshold for the refined prompts and a refined prompts limit.

The refined prompts may be obtained by feeding the prompt and/or contextual information from the contextual information data source to a style alignment model as input. The style alignment model may output corresponding refined prompts (e.g., to the input).

In addition to the prompt, the contextual information may also be fed to the style alignment model. The contextual information may be obtained via a retrieval augmented generation process or other type of collection process. In an embodiment, permissions, roles, or other types of user-focused management data may be used as part of the contextual information. The aforementioned information may be used to, for example, identify the contextual information data source (e.g., the requestor may be privileged with response to some but not all contextual information data sources).

The refined prompts may be obtained by obtaining, using the contextual information data source, chunks of information (e.g., based on similarity between the prompt and different chunks in the contextual information data source); and assigning portions of the chunks of information for contextualization of the respective refined prompts using an assignment algorithm (e.g., may be random, may enforce a distribution using a seeding process and/or algorithm, etc.).

At least a portion of the contextual information for the refined prompts may be derived from permissions granted to the requestor. For example, the permissions may be used to identify and/or infer a type of the requestor, a task assigned to the requestor, etc. The identified/inferred information may be used as part of the contextual information.

A refined prompt may include a revised statement that is based on: the prompt; the portion of the contextual information; and a portion of information from the contextual information data source.

When generating refined prompts, the refined prompts may be scored and compared to the score threshold. The score threshold may include a quantification for discriminating acceptable refined prompts from unacceptable refined prompts. Refined prompts may continue to be generated until one has a score that exceeds the score threshold (or a predetermined number exceed the score threshold), or the refined prompt limit is reached (e.g., the refined prompts limit may indicate a maximum number that may be generated).

The refined prompts may be scored using a scoring system, which may be deterministic.

The refined prompts limit may change over time based on scores ascribed to past generated refined prompt-response pairs (e.g., using at least the scoring system). As the scores improve (e.g., indicating that the style alignment model is generating more desirable refined prompts), the refined prompts limit may be reduced (and the vice versa) and/or other management information (e.g., may require fewer predetermined numbers that exceed the limit for the generation process to be terminated before the refined prompts limit is reached).

Each refined prompt-response pair of the refined prompt-response pairs may include one of the number of refined prompts; and one of the corresponding responses. The scoring system ascribes a first partial score to the one of the number of refined prompts and a second partial score to the one of the corresponding responses, and an aggregate score based on the first partial score and the second partial score.

The style alignment model may be implemented using a trained generative machine learning model having attention layers. The trained generative machine learning model may be a fine-tuned version of a frontier model or other type of trained model. The fine tuning may modify the attention layers to modify the types of responses generated by the trained generative machine learning model.

The fine tuning may be performed using refinement data (e.g., training data). The refinement data may include any of previously serviced prompts; previously generated refined prompts for the serviced prompts; previously generated responses to the previously generated refined prompts; and scores ascribed to the previously generated responses and/or refined prompts. The content of the refinement data may be focused on a particular information domain (e.g., focused on an industry, a type of process, etc.). The fine tuning may be performed using any refinement process, and may result in a model that is more likely to produce desirable refined prompts. Both the style alignment model and the trained generative machine learning model may be fine-tuned for the same information domain (e.g., both trained using training data relevant to the information domain).

At operation 334, corresponding responses for the refined prompts may be generated using the trained generative machine learning model to obtain refined prompt-response pairs. The corresponding responses may be generated by feeding the refined prompts to the trained generative machine learning model as input.

At operation 336, the refined prompt-response pair may be scored using at least one scoring system to identify a best ranked refined prompt-response pair of the refined prompt-response pairs.

The at least one scoring system may include a first scoring system for scoring refined prompts; and a second scoring system for scoring the corresponding responses. The at least one scoring system may also include a schema for combining a score from the first scoring system with a score from the second scoring system to obtain a score for the refined prompt-response pair of the refined prompt corresponding response pairs. The schema may specify weights for a weighted sum of the score from the first scoring system and the score from the second scoring system.

The first scoring system, the second scoring system, and the schema may each be deterministic.

The second scoring system may use natural language processing results of respective corresponding responses as input. For example, the corresponding responses may be processed with natural language processing to extract certain information from the corresponding responses, and the second scoring system may be keyed to the extracted certain information. For example, the natural language processing results may be quantitative assessments of the respective corresponding responses.

At operation 338, one of the corresponding responses is selected. The one may be selected, for example, on a basis of likely desirability of the responses and/or the refined prompts. The scores ascribed to the refined prompt-response pairs may be used to rank the desirability of the responses and/or the refined prompts. The best ranked may be used as the one of the corresponding responses.

At operation 340, the one of the corresponding responses may be used to service the prompt. The one may be used by (i) providing the one of the corresponding responses to the entity (or designated recipient), (ii) selecting and performing one or more actions based on the one of the corresponding responses (to provide computer implemented services that are more likely to be deemed to be desirable), and/or via other methods.

For example, a response package may be generated based at least on the one of the corresponding responses. The response package may be provided to an entity that initiated the prompt. The entity may provide feedback regarding the desirability of any of the corresponding responses based on the response package.

For example, multiple responses may be provided (as part of the response package) and a user may ascribe relative or absolute levels of desirability for the respective responses.

The method may end following operation 340.

In addition to the above operation, the feedback may be used to update operation of the trained generative machine learning model and/or the style alignment model. For example, a training data set may be established using all, or a portion, of the generated refined prompt-response pairs, the entity ascribed levels of desirability of the respective responses, and/or scores for the refined prompt-response pairs (and/or portions thereof). The training data may be used to perform, for example, fine-tuning, reinforced learning, and/or other model updating processes.

Additionally, the training data may be used to refine limits on the refined prompts that are generated. For example, as desirability increases, the limits on the refined prompts that are generated (e.g., at operation 302) may be reduced to reduce computational expenditures.

Thus, using the flow shown in FIG. 3D, embodiments disclosed herein may facilitate scoring of refined prompt-response pairs.

Turning to FIG. 3E, a fifth flow diagram illustrating a method for servicing requests in accordance with an embodiment is shown. The method may be performed by any of the components of FIG. 1, and/or other entities without departing from embodiments disclosed herein.

At operation 350, a prompt for processing by a trained generative machine learning model may be obtained. The prompt may be obtained by reading it from storage, receiving it from another entity, generating it (e.g., based on user input), and/or via other methods.

For example, a user may use a chatbot, portal, or other interface to provide user input usable to define the prompt. The prompt may include free form text in a style aligned with that of the user (as opposed to entities that may use the resulting prompt).

In another example, the prompt may be defined using an application program interface (e.g., by a different program from the program presenting the application program interface). For example, the other program may use a language model or other entity to generate free form text defining an intent, goal, etc. The application program interface may direct the content to the request processing pipeline.

At operation 352, a number of refined prompts that are based on the prompt may be obtained. The number may be based on a score threshold for the refined prompts and a refined prompts limit.

The refined prompts may be obtained by feeding the prompt and/or contextual information from the contextual information data source to a style alignment model as input. The style alignment model may output corresponding refined prompts (e.g., to the input).

In addition to the prompt, the contextual information may also be fed to the style alignment model. The contextual information may be obtained via a retrieval augmented generation process or other type of collection process. In an embodiment, permissions, roles, or other types of user-focused management data may be used as part of the contextual information. The aforementioned information may be used to, for example, identify the contextual information data source (e.g., the requestor may be privileged with response to some but not all contextual information data sources).

The refined prompts may be obtained by obtaining, using the contextual information data source, chunks of information (e.g., based on similarity between the prompt and different chunks in the contextual information data source); and assigning portions of the chunks of information for contextualization of the respective refined prompts using an assignment algorithm (e.g., may be random, may enforce a distribution using a seeding process and/or algorithm, etc.).

At least a portion of the contextual information for the refined prompts may be derived from permissions granted to the requestor. For example, the permissions may be used to identify and/or infer a type of the requestor, a task assigned to the requestor, etc. The identified/inferred information may be used as part of the contextual information.

A refined prompt may include a revised statement that is based on: the prompt; the portion of the contextual information; and a portion of information from the contextual information data source.

When generating refined prompts, the refined prompts may be scored and compared to the score threshold. The score threshold may include a quantification for discriminating acceptable refined prompts from unacceptable refined prompts. Refined prompts may continue to be generated until one has a score that exceeds the score threshold (or a predetermined number exceed the score threshold), or the refined prompt limit is reached (e.g., the refined prompts limit may indicate a maximum number that may be generated).

The refined prompts may be scored using a scoring system, which may be deterministic.

The refined prompts limit may change over time based on scores ascribed to past generated refined prompt-response pairs (e.g., using at least the scoring system). As the scores improve (e.g., indicating that the style alignment model is generating more desirable refined prompts), the refined prompts limit may be reduced (and the vice versa) and/or other management information (e.g., may require fewer predetermined numbers that exceed the limit for the generation process to be terminated before the refined prompts limit is reached).

Each refined prompt-response pair of the refined prompt-response pairs may include one of the number of refined prompts; and one of the corresponding responses. The scoring system ascribes a first partial score to the one of the number of refined prompts and a second partial score to the one of the corresponding responses, and an aggregate score based on the first partial score and the second partial score.

The style alignment model may be implemented using a trained generative machine learning model having attention layers. The trained generative machine learning model may be a fine-tuned version of a frontier model or other type of trained model. The fine tuning may modify the attention layers to modify the types of responses generated by the trained generative machine learning model.

The fine tuning may be performed using refinement data (e.g., training data). The refinement data may include any of previously serviced prompts; previously generated refined prompts for the serviced prompts; previously generated responses to the previously generated refined prompts; and scores ascribed to the previously generated responses and/or refined prompts. The content of the refinement data may be focused on a particular information domain (e.g., focused on an industry, a type of process, etc.). The fine tuning may be performed using any refinement process, and may result in a model that is more likely to produce desirable refined prompts. Both the style alignment model and the trained generative machine learning model may be fine-tuned for the same information domain (e.g., both trained using training data relevant to the information domain).

At operation 354, corresponding responses for the refined prompts may be generated using the trained generative machine learning model to obtain refined prompt-response pairs. The corresponding responses may be generated by feeding the refined prompts to the trained generative machine learning model as input.

At operation 336, one of the corresponding responses may be selected using a scoring system. To make the selection, the refined prompt-response pairs may be scored using a scoring system to identify a best ranked refined prompt-response pair of the refined prompt-response pairs.

The scoring system may be a multidimensional scoring system. The multidimensional scoring systems may be adapted to generates sub-scores for at least: sentiment; relevancy; clarity; fairness; and conciseness.

The sentiment may quantify a likelihood of a given response being viewed as emotionally positive to a requestor. The relevancy may quantify a likelihood of a given response to be viewed as satisfying at least one questions present in the prompt. The conciseness may be based on a ratio of words in a given response deemed to be important to a total number of words in the given response.

The multidimensional scoring system may generate sub-scores for the refined prompt and a response of any number of refined prompt-responses generated as part of operations 352-354. The sub-scores may be combined to obtain an aggregate score for each of the refined prompt-response pairs. The aggregate scores may be used to rank order the refined prompt-response pairs. The response from the best ranked refined prompt-response pair may be used as the one of the corresponding responses.

At operation 358, the one of the corresponding responses may be used to service the prompt. The one may be used by (i) providing the one of the corresponding responses to the entity (or designated recipient), (ii) selecting and performing one or more actions based on the one of the corresponding responses (to provide computer implemented services that are more likely to be deemed to be desirable), and/or via other methods.

For example, a response package may be generated based at least on the one of the corresponding responses. The response package may be provided to an entity that initiated the prompt. The entity may provide feedback regarding the desirability of any of the corresponding responses based on the response package.

For example, multiple responses may be provided (as part of the response package) and a user may ascribe relative or absolute levels of desirability for the respective responses.

The method may end following operation 358.

In addition to the above operation, the feedback may be used to update operation of the trained generative machine learning model and/or the style alignment model. For example, a training data set may be established using all, or a portion, of the generated refined prompt-response pairs, the entity ascribed levels of desirability of the respective responses, and/or scores for the refined prompt-response pairs (and/or portions thereof). The training data may be used to perform, for example, fine-tuning, reinforced learning, and/or other model updating processes.

Additionally, the training data may be used to refine limits on the refined prompts that are generated. For example, as desirability increases, the limits on the refined prompts that are generated (e.g., at operation 302) may be reduced to reduce computational expenditures.

Thus, using the flow shown in FIG. 3E, embodiments disclosed herein may facilitate scoring of refined prompt-response pairs.

Embodiments disclosed herein may be implemented with one or more computing devices. Turning to FIG. 4, a block diagram illustrating an example of a data processing system (e.g., a computing device) in accordance with an embodiment is shown.

For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processors can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device.

For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for servicing requests, the method comprising:
obtaining a prompt for processing by a trained generative machine learning model;
perturbating the prompt using a style alignment model;
obtaining, using a tuned language model and a retrieval-augmented generation (RAG) system, a number of refined prompts based at least on the prompt, the number being based on score threshold for the refined prompts and refined prompts limit;
generating corresponding responses for the number of the refined prompts using the trained generative machine learning model;
selecting one of the corresponding responses; and
using the one of the corresponding responses to service the prompt.

2. The method of claim 1, wherein the score threshold is a quantification for discriminating acceptable refined prompts from unacceptable refined prompts.

3. The method of claim 2, wherein obtaining the number of refined prompts comprises:
iteratively generating ones of the refined prompts until:
a one of the ones of the refined prompts is ascribed a score that meets the score threshold, or
a number of the ones of the refined prompts meets the refined prompts limit.

4. The method of claim 3, wherein the refined prompts limit indicates a maximum allowable number of refined prompts that are to be generated for the prompt.

5. The method of claim 1, wherein obtaining the number of the refined prompts comprises:
scoring each of the number of the refined prompts using a scoring system.

6. The method of claim 5, wherein the scoring system is deterministic.

7. The method of claim 6, wherein the refined prompts limit is set based on scores ascribed to past generated refined prompt-response pairs using at least the scoring system.

8. The method of claim 7, wherein each refined prompt-response pair of the refined prompt-response pairs comprises:
one of the number of refined prompts; and
one of the corresponding responses.

9. The method of claim 8, wherein the scoring system ascribes a first partial score to the one of the number of refined prompts and a second partial score to the one of the corresponding responses, and an aggregate score based on the first partial score and the second partial score.

10. The method of claim 1, wherein the prompt is obtained from one selected from a group consisting of:
a chat interface of a computer program that provides desired computer implemented services;
a portal; and
an application programming interface.

11. The method of claim 1, wherein using the one of the corresponding responses comprises:
generating a response package based at least on the one of the corresponding responses;
providing the response package to an entity that initiated the prompt; and
obtaining feedback from the entity regarding a desirability of the one of the corresponding responses.

12. The method of claim 11, wherein the desirability of the one of the corresponding responses is expressed as a preference between the one of the corresponding responses and another of the corresponding responses.

13. The method of claim 12, further comprising:
updating operation of the trained generative machine learning model based, at least in part, on the desirability of the one of the corresponding responses.

14. The method of claim 13, further comprising:
updating the style alignment model based, at least in part, on the desirability of the one of the corresponding response, the number of refined prompts being obtained using, at least in part, the style alignment model.

15. The method of claim 12, further comprising:
supplementing, using the RAG system, the refined prompts with contextual data from a data repository, wherein the prompt comprises a query relating trip planning, and wherein the contextual data comprises a location of a user and historical travel data of the user.

16. A non-transitory machine-readable medium having instructions stored therein, which when executed by a processor, cause operations for servicing requests to be performed, the operations comprising:
obtaining a prompt for processing by a trained generative machine learning model;
perturbating the prompt using a style alignment model;
obtaining, using a tuned language model and a retrieval-augmented generation (RAG) system, a number of refined prompts based at least on the prompt, the number being based on score threshold for the refined prompts and refined prompts limit;
generating corresponding responses for the number of the refined prompts using the trained generative machine learning model;
selecting one of the corresponding responses; and
using the one of the corresponding responses to service the prompt.

17. The non-transitory machine-readable medium of claim 16, wherein the score threshold is a quantification for discriminating acceptable refined prompts from unacceptable refined prompts.

18. The non-transitory machine-readable medium of claim 17, wherein obtaining the number of refined prompts comprises:
iteratively generating ones of the refined prompts until:
a one of the ones of the refined prompts is ascribed a score that meets the score threshold, or
a number of the ones of the refined prompts meets the refined prompts limit.

19. A system, comprising:
a processor; and
a memory coupled to the processor to store instructions, which when executed by the processor, cause operations for servicing requests to be performed, the operations comprising:
obtaining a prompt for processing by a trained generative machine learning model;
perturbating the prompt using a style alignment model;
obtaining, using a tuned language model and a retrieval-augmented generation (RAG) system, a number of refined prompts based at least on the prompt, the number being based on score threshold for the refined prompts and refined prompts limit;
generating corresponding responses for the number of the refined prompts using the trained generative machine learning model;
selecting one of the corresponding responses; and
using the one of the corresponding responses to service the prompt.

20. The system of claim 19, wherein the score threshold is a quantification for discriminating acceptable refined prompts from unacceptable refined prompts.
